(19) United States
(12) Patent Application Publication
(10) Pub. No.: US 2020/0409823 A1
(43) Pub. Date: Dec. 31, 2020

(54) METHOD AND APPARATUS FOR OPTIMAL DISTRIBUTION OF TEST CASES AMONG DIFFERENT TESTING PLATFORMS

(71) Applicant: Robert Bosch GmbH, Stuttgart (DE)

(72) Inventors: Joachim Sohns, Ludwigsburg (DE); Christoph Gladisch, Renningen (DE); Thomas Heinz, Stuttgart (DE)

(21) Appl. No.: 16/870,461

(22) Filed: May 8, 2020

(30) Foreign Application Priority Data
Jun. 28, 2019 (DE) 102019209540.2

(51) Int. Cl. G06F 11/36; G06F 16/23; G06F 16/2453; G06N 20/00; G06N 7/00

(52) U.S. Cl. CPC G06F 11/3664; G06F 16/2379; G06N 7/005; G06N 20/00; G06F 16/2453

(57) ABSTRACT

A method for optimizing test cases. The method includes the following features. On the basis of simulation data obtained by way of the simulation, a simulation metamodel is created. On the basis of measurements performed in the test environment, a reality metamodel is created. Uncertainties inherent in the simulation data and measurements are combined by the fact that either the sum is calculated or the worst case of the two calculations is used or the worst case is respectively considered for each uncertainty being considered. On the basis of the combination of the uncertainties, a metamodel encompassing the simulation and the test environment is created. A search-based optimization of the test cases is performed by way of the metamodel.

### CROSS REFERENCE

The present application claims the benefit under 35 U.S.C. § 119 of German Patent Application No. DE 102019209540.2 filed on Jun. 28, 2019, which is expressly incorporated herein by reference in its entirety.

### FIELD

The present invention relates to a method for optimal distribution of test cases among different testing platforms. The present invention furthermore relates to a corresponding apparatus, to a corresponding computer program, and to a corresponding storage medium.

### BACKGROUND INFORMATION

In software engineering, the utilization of models in order to automate testing activities and generate test artifacts in the testing process is referred to in general as “model-based testing” (MBT). The generation of test cases from models that describe the intended behavior of the system being tested is, for example, sufficiently known.

Embedded systems, in particular, rely on coherent input signals of sensors, and in turn stimulate their environment by way of output signals to a wide variety of actuators. In the course of verification and preliminary development phases of such a system, a model (model in the loop, MiL), software (software in the loop, SiL), processor (processor in the loop, PiL), or overall hardware (hardware in the loop, HiL) of a control loop is therefore simulated in that loop together with a model of the surroundings. In automotive engineering, simulators in accordance with this principle for testing electronic control devices are in some cases referred to, depending on the test phase and test object, as component test stands, model test stands, or integration test stands.

German Patent Application No. DE 10303489 A1 describes a method for testing software of a control unit of a vehicle, in which a controlled system controllable by the control unit is at least partly simulated by a test system by the fact that output signals are generated by the control unit and those output signals of the control unit are transferred to first hardware modules via a first connection and signals of second hardware modules are transferred as input signals to the control unit via a second connection, the output signals being furnished as first control values in the software and additionally being transferred via a communication interface to the test system in real time with reference to the controlled system.

Simulations of this kind are common in various technological sectors and are utilized, for example, in order to test embedded systems in power tools, in engine control devices for drive systems, steering systems, and braking systems, or even in autonomous vehicles, for suitability in their early development phases. The results of simulation models according to the existing art are nevertheless incorporated only to a limited extent in release decisions due to a lack of confidence in their reliability.

### SUMMARY

The present invention provides, e.g., a method for optimal distribution of test cases among different testing platforms; a corresponding apparatus; a corresponding computer program; and a corresponding storage medium.

The approach according to the present invention is based on the recognition that the models are generally validated, and their trustworthiness evaluated, on the basis of specially selected validation measurements. In working groups and projects, criteria are developed for when a simulation is considered reliable and when real tests can be replaced by simulations. Simulation models in many cases are validated on the basis of expert knowledge and quantitative metrics. An established method with which, on the basis of validation measurements, the accuracy of a simulation-based test can be quantitatively determined does not yet seem to exist.

In light of the above, an example method in accordance with the present invention formalizes the requirement for a test case in such a way that it is met if a variable (KPI) that characterizes the requirement is above a predefined threshold and if uncertainties are taken into account. Those uncertainties can be caused by uncertainties in the system, statistical dispersions of parameters, or model errors. In the case of the model (10) shown in FIG. 1, in the region (12) of a confidence interval (13) that lies below the threshold (11), there is a large risk that the test case will not be complied with. The confidence interval can be defined in various ways. The upper and lower limits can also be calculated in various ways, for example:
using a metamodel, e.g. a Gaussian process or another machine-learning model that describes the model error on the signal level and on the basis of which the error KPI of the test case is calculated; or
using the variation of signals in the context of known error patterns and uncertainties, and evaluating the test case for those artificially generated signals; or
by determining uncertainties in the system and by varying pertinent parameters; or
by extrapolating and interpolating the available information in the context of a metamodel.

In practice, real tests can be carried out only for a limited number of points in the parameter space (14). Search-based testing (SBT) is used to determine, in an iterative process based on predefined criteria, the closest respective point in the parameter space at which a simulation or a real experiment is to be carried out.

Based on the simulations and measurements that have been carried out for model validation, a statement is made regarding the trustworthiness of the simulation with regard to a test case. The example method according to the present invention makes it possible to evaluate the accuracy of a simulation model with regard to a test case even if the relevant test has not been carried out in reality using the same parameter set. The methods presented furthermore provide a test strategy for ascertaining the test cases in a large test space. The algorithms furthermore provide indicators as to which test cases were ascertained in reality and which were ascertained on the basis of simulation. Several problems are investigated in the present document. For each of these problems, a variety of procedures exist which differ in that the tester or simulation engineer possesses different information.

A first problem relates to estimating uncertainties based on simulation models and real measured data, and evaluating how much influence those uncertainties have on the result of test cases. On that foundation, new test cases are determined which are investigated in the simulation or the real test.

A second problem relates to deriving requirements as to the accuracy of simulation models on the basis of test cases. The accuracy that is necessary depends on the selection of test cases. Those requirements can be used to define additional validation measurements or to improve the model.

The validation of models is usually carried out on the basis of predefined stimuli. The results of the simulation and of the real measurement are compared based on expert knowledge and quantitative metrics (e.g. per ISO 18571). Once the model is validated, it is then assumed that the simulation also provides a credible result in a context of other stimuli.

The example embodiment of the present invention makes it possible to create a direct correlation between validation measurements and the simulation accuracy with regard to a test case. The method supplies indicators as to which test cases were tested in reality, and which based on simulation.

Advantageous refinements of and improvements to the example embodiment of the present invention are possible due to the features described herein.

### BRIEF DESCRIPTION OF THE DRAWINGS

Exemplifying embodiments of the present invention are depicted in the figures and are explained in further detail below.

FIG. 1 shows the test case KPI as a function of parameters (p), the uncertainty bands, and the limit value for the test case.

FIG. 2 shows a method based on metamodels, according to a first embodiment of the present invention.

FIG. 3 shows the use of heuristic, parameterizable error models, according to a second embodiment of the present invention.

FIG. 4 shows the use of artificial signal patterns for the error in consideration of the known simulation accuracy, according to a third embodiment of the present invention.

FIG. 5 shows the derivation of the required simulation accuracy.

FIG. 6 shows the derivation of the required simulation quality on the basis of artificial error patterns.

FIG. 7 schematically shows a workstation according to a second embodiment of the present invention.

### DETAILED DESCRIPTION OF EXAMPLE EMBODIMENTS

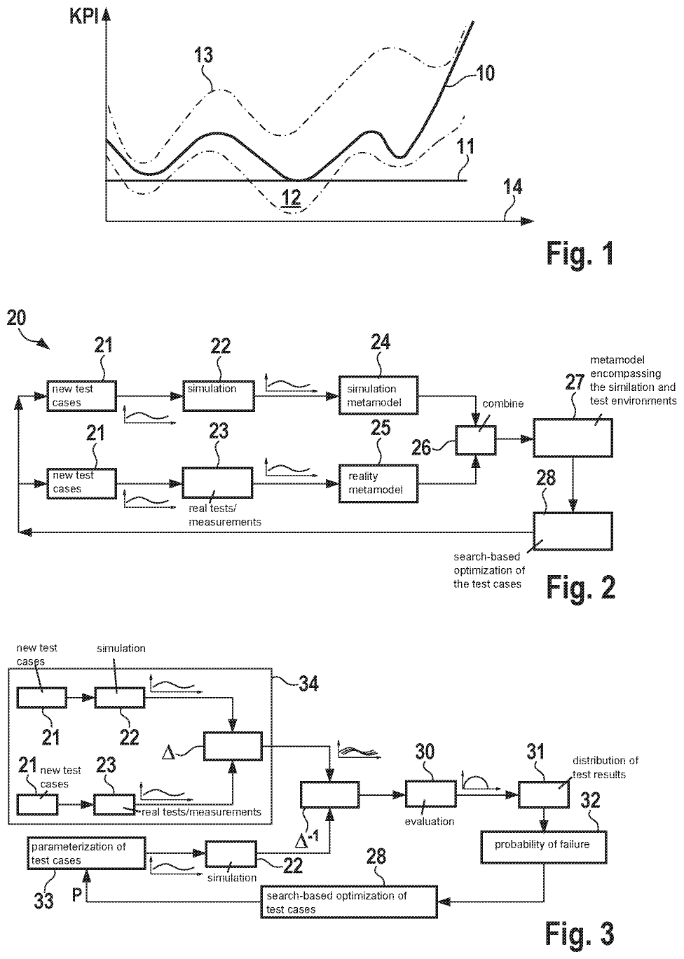

FIG. 2 illustrates the use of metamodels (24, 25), for instance Gaussian processes, to select new test cases (21). Proceeding from specific simulation models, including modeled uncertainties, new test cases for simulation (22) and real tests (23) are thereby looked for.

Both real measurements and simulation data are used to create the metamodels (24, 25). These metamodels are updated when new data are available, and in some cases acquire uncertainties from the data. The two metamodels (24, 25) are combined into one new metamodel (27) using a method (23), as soon as the metamodels (24, 25) are updated on the basis of new data (22, 23). The metamodel (27) thus permits both a prediction of new data and a combined prediction of the uncertainties based on data from the simulation (22) and from real measurements (23). The combination (27) can be effected using various approaches, for instance (but not exclusively):
calculating averages, minima, or maxima of the predicted values and the uncertainties from the metamodels (24, 25); or
creating a new Gaussian process from the predicted data from (24) and (25).

The combined metamodel (27) is used by a test generation method (28) to generate new test cases (21). One embodiment of the test generation method (28) is, for instance, SBT. The methods that are presented in more detail in the sections below can be construed as special cases of or supplements to this method (20).

FIG. 3 illustrates the use of heuristic error patterns to select new test cases (21). Simulation models exist here as well (although uncertainties do not explicitly need to be modeled as such), as well as a set of simulation data with pertinent real measurements. A search is made for new test cases (21) for simulation (22) and real tests (23) in which the risk of a failure is high (32).

For this purpose, in the first step the deviation (Δ) between the real measurements and the experiments is considered. Typical error patterns, for example phase shifts, amplitude errors, or typical additive signals such as oscillations, are derived from the signal comparison. These errors are considered at one or several points in the test space on the assumption that the simulated signal profiles exhibit similar error patterns at different points in the test space and can be rescaled, for example with regard to unmodeled physical effects or similar types of uncertainty. No consideration is given to how those errors occur. Instead, heuristic error models are used which reproduce the observed deviations. At points in the test space which have not been considered in reality, those error models are used as the basis for simulating (22) a “simulation error” and the effect of uncertainties. With the aid of the ascertained uncertainties and the SBT method (28), those regions in the parameter space at which the risk of violating the test case (32) is high are ascertained.

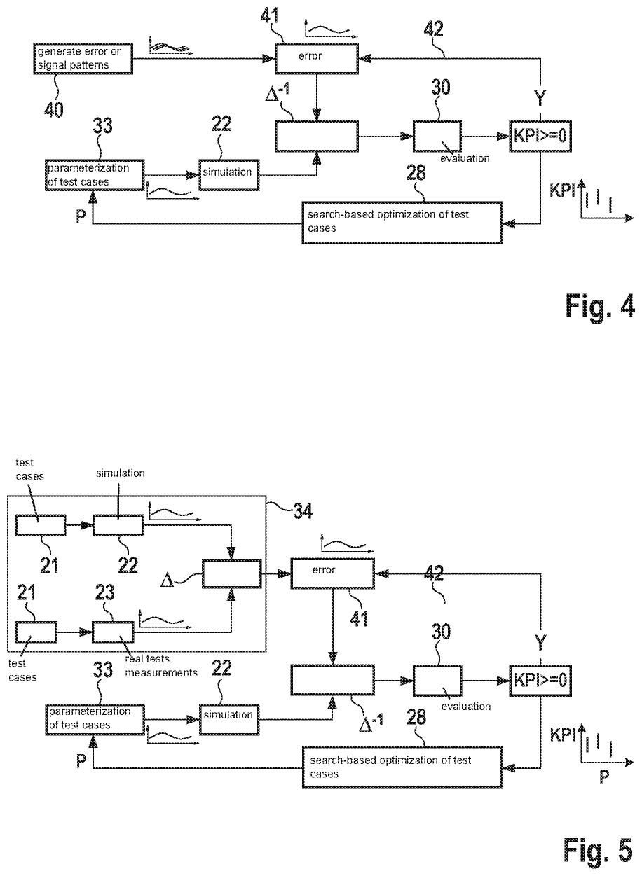

FIG. 4 shows the generation of artificial error patterns (40) for selecting new test cases (21). This also shows the simulation model (although uncertainties do not explicitly need to be modeled as such), as well as their accuracy ascertained using a signal-based metric (KPI). What is wanted is again new test cases (21) for simulation (22) and real tests (23) in which the risk of a failure is high (32).

The method is similar to the method depicted in FIG. 3. Measured errors (“heuristic error model”) are not used, however, for simulation (22) of the test cases (21). Instead, typical signal patterns (40) that are compatible with the type of validation metric (KPI) and the ascertained signal accuracy are generated, for example by generating phase shifts or adding noise patterns that lie within a specific corridor.

FIG. 5 illustrates the derivation of requirements for the accuracy of simulation models on the basis of heuristic error models. Simulation models are provided, as well as a set of simulation data and pertinent real measurements, and a heuristic, parameterizable error model. The objective of this embodiment is iterative discovery of new test cases (21) for which a high model accuracy is required. These test cases (21) are investigated in reality (23) and by simulation (22) in order to ascertain whether the requisite simulation accuracy exists.

This method as well is similar to the method depicted in FIG. 3, except that for each test case (21), the size of the error (41) is modified in an internal loop until the test case (21) fails. The last value for which the test case (21) is still met indicates the maximum permitted error (41), and thus defines the required simulation quality. The SBT algorithm (28) looks for points in the test space at which a high model accuracy is required. At those points, the model accuracy can be tested using real measurements (23) and simulations (22).

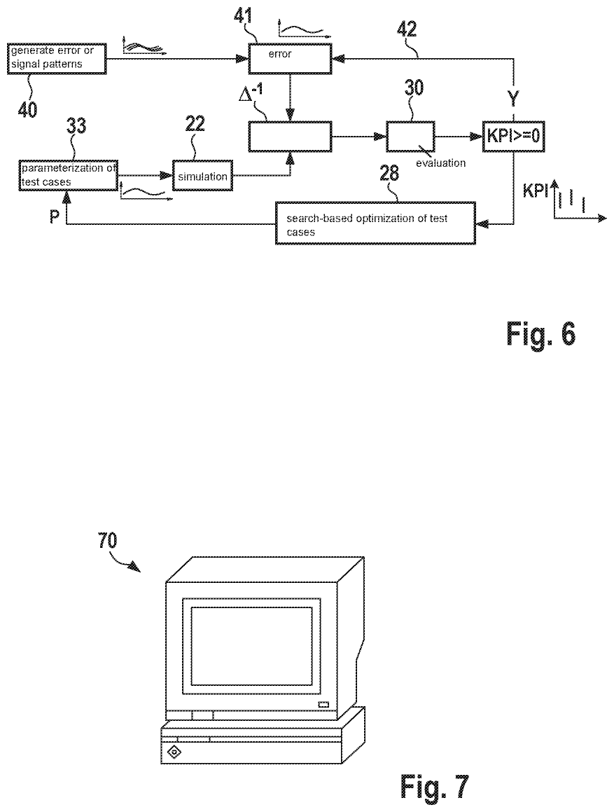

FIG. 6 illustrates the derivation of requirements for the accuracy of simulation models on the basis of heuristic error models. Once again the simulation models are provided (although uncertainties do not explicitly need to be modeled as such), as is their accuracy ascertained using a signal-based metric (KPI). The objective of this embodiment as well is iterative discovery of new test cases (21) for which a high model accuracy is required. These test cases (21) are investigated in reality (23) and by simulation (22) in order to ascertain whether the requisite simulation accuracy exists.

This method is similar to the method depicted in FIG. 5, except that measured errors (“heuristic error model”) are not used to simulate the test cases (21). Instead, typical signal patterns (40) that are compatible with the type of validation metric (KPI) and the ascertained signal accuracy are generated, for instance by generating phase shifts, shifts in the frequency domain, filters (e.g. high-pass or low-pass filters), addition of noise patterns that lie within a specific corridor, or other established signal-processing methods.

This method can be implemented, for example, in software or hardware or in a mixed form of software and hardware, for example in a workstation (70) as illustrated by the schematic depiction of FIG. 7.

Example embodiments of the present invention are further described in the following paragraphs.

Paragraph 1. A method (20) for optimal distribution of test cases among different test platforms (21) for a simulation (22) and test environment (23) of a system embedded in particular in an at least semi-autonomous robot or vehicle,
characterized by the following features:
   on the basis of simulation data obtained by way of the simulation (22), a simulation metamodel (24) is created;
   on the basis of measurements performed in the test environment (23), a reality metamodel (25) is created; the simulation data and measured data, as well as the respective inherent uncertainties, are combined in (26), for instance by calculating the averages, minima, or maxima of the predicted values and of the uncertainties from the metamodels (24, 25), or by establishing a new Gaussian process from the predicted data from the models (24, 25);
   on the basis of the combination (26) of the uncertainties, a metamodel (27) encompassing the simulation (22) and the test environment (23) is created; and
   a search-based optimization (28) of the test cases (21) is performed by way of the metamodel (27).

Paragraph 2. The method as recited in Paragraph 1, characterized by the following features:
error patterns typical of the simulation (22) are derived from the simulation data and from the measurements;
based on the error patterns, an evaluation (30) of at least one of the test cases (21) is performed;
by way of the evaluation (30), the distribution (31) of the test results is ascertained depending on a parameter (p) that parameterizes the test cases with respect to the tested requirement;
based on the distribution (30), a probability, depending on the parameter (p), of a failure (32) of the test case (21) is investigated; and
by way of the parameter (p), a parameterization (33) of the test cases (21) is performed.

Paragraph 3. The method (20) as recited in Paragraph 2, characterized by the following feature:
based on the performance index (KPI), signal patterns (40) that are typical of an error (41) are generated.

Paragraph 4. The method (20) as recited in Paragraph 3, characterized by the following feature:
an amplitude or magnitude of the error is scaled (42) for one of the signal patterns.

Paragraph 5. The method (20) as recited in one of Paragraphs 2 to 4, wherein the error patterns or signal patterns (40) encompass at least one of the following:
a phase shift;
amplitude errors;
time-dependent additive signals;
shifts in the frequency domain;
convolutions having a kernel in the time domain (e.g. typical high-pass or low-pass behavior); or
other known error patterns that are reproduced or detected by an established metric.

Paragraph 6. The method (20) as recited in one of Paragraphs 1 to 5, characterized by the following feature:
the metamodels (24, 25, 27) are calculated using Bayesian statistics or another established method for calculating metamodels, for instance from the field of machine learning.

Paragraph 7. The method (20) as recited in one of Paragraphs 1 to 6, characterized by the following features:
the simulation (22) and the measurements either are performed once at the beginning of the method (20) or are repeated during the method for different parameterizations of the test case, such that the execution of further tests can be carried out both by simulation and using a real experiment; and
data from measurements or simulations that have been carried out again are used to adapt the metamodels or to adapt the error models.

Paragraph 8. The method (20) as recited in one of Paragraphs 1 to 7, wherein an automatic improvement of errors in the system which are recognized by the simulation (22) is accomplished by the optimization (28).

Paragraph 9. A computer program that is configured to execute the method (20) as recited in one of Paragraphs 1 to 8.

Paragraph 10. A machine-readable storage medium on which the computer program as recited in Paragraph 9 is stored.

Paragraph 11. An apparatus (70) that is configured to execute the method (20) as recited in one of Paragraphs 1 to 8.

What is claimed is:

1. A method for optimal distribution of test cases among different test platforms for a simulation and test environment of a system embedded in an at least semi-autonomous robot or vehicle, the method comprising the following steps:
creating a simulation metamodel based on simulation data obtained using the simulation;
creating a reality metamodel based on measured data of measurements performed in the test environment;
combining the simulation data, the measured data, and respective inherent uncertainties, by: (i) calculating averages, or minima, or maxima of predicted values and of uncertainties from the simulation metamodel and the reality metamodel, or (ii) establishing a Gaussian process from predicted data from the simulation metamodel and the reality metamodel;
creating a combined metamodel encompassing the simulation and the test environment based on the combining; and
performing a search-based optimization of the test cases using the combined metamodel.

2. The method as recited in claim 1, further comprising the following steps:
deriving error patterns typical of the simulation from the simulation data and from the measured data;
performing an evaluation of at least one of the test cases based on the error patterns;
ascertaining, by way of the evaluation, a distribution of test results depending on a parameter that parameterizes the test cases with respect to a tested requirement;
determining, based on the distribution, a probability, depending on the parameter, of a failure of the test case; and
performing, using the parameter, a parameterization of the test cases.

3. The method as recited in claim 2, wherein signal patterns that are typical of an error are generated based on a performance index.

4. The method as recited in claim 3, wherein an amplitude or magnitude of the error is scaled for one of the signal patterns.

5. The method as recited in claim 2, wherein the error patterns include at least one of the following:
a phase shift; and/or
amplitude errors; and/or
time-dependent additive signals; and/or
shifts in a frequency domain; and/or
convolutions having a kernel in a time domain; and/or
other error patterns that are reproduced or detected by an established metric.

6. The method as recited in claim 1, wherein the simulation metamodel, the reality metamodel, and the combined metamodel are created using Bayesian statistics.

7. The method as recited in claim 1, wherein the simulation metamodel, the reality metamodel, and the combined metamodel are created using machine learning.

8. The method as recited in claim 1, wherein:
the simulation and the measurements either are performed once at a beginning of the method or are repeated during the method for different parameterizations of the test case, such that the execution of further tests can be carried out both by simulation and using a real experiment; and
data from the simulation or the measurements carried out again are used to adapt: (i) the simulation metamodel, the reality metamodel, or (ii) error models.

9. The method as recited in claim 1, wherein an automatic improvement of errors in the system which are recognized by the simulation is accomplished by the optimization.

10. A non-transitory machine-readable storage medium on which is stored a computer program for optimal distribution of test cases among different test platforms for a simulation and test environment of a system embedded in an at least semi-autonomous robot or vehicle, the computer program, when executed by a computer, causing the computer to perform the following steps:
creating a simulation metamodel based on simulation data obtained using the simulation;
creating a reality metamodel based on measured data of measurements performed in the test environment;
combining the simulation data, the measured data, and respective inherent uncertainties, by: (i) calculating averages, or minima, or maxima of predicted values and of uncertainties from the simulation metamodel and the reality metamodel, or (ii) establishing a Gaussian process from predicted data from the simulation metamodel and the reality metamodel;
creating a combined metamodel encompassing the simulation and the test environment based on the combining; and
performing a search-based optimization of the test cases using the combined metamodel.

11. An apparatus for optimal distribution of test cases among different test platforms for a simulation and test environment of a system embedded in an at least semi-autonomous robot or vehicle, the apparatus configured to:
create a simulation metamodel based on simulation data obtained using the simulation;
create a reality metamodel based on measured data of measurements performed in the test environment;
combine the simulation data, the measured data, and respective inherent uncertainties, by: (i) calculating averages, or minima, or maxima of predicted values and of uncertainties from the simulation metamodel and the reality metamodel, or (ii) establishing a Gaussian process from predicted data from the simulation metamodel and the reality metamodel;
create a combined metamodel encompassing the simulation and the test environment based on the combining; and
perform a search-based optimization of the test cases using the combined metamodel.
